(19) United States
(12) Patent Application Publication
(10) Pub. No.: US 2003/0015283 A1
(43) Pub. Date: Jan. 23, 2003

(54) Compressed water-hyacinth fiber board and method of manufacture

(76) Inventor: Kenneth Ian Markland, Coral Springs, FL (US)

Correspondence Address: Oltman, Flynn & Kubler, 415 Galleria Professional Building, 915 Middle River Drive, Ft. Lauderdale, FL, 33304, US

(21) Appl. No.: 09/908,522

(22) Filed: Jul. 18, 2001

(51) Int. Cl. B32B 1/00; B29C 47/00

(52) U.S. Cl. 156/245; 264/109; 156/296

(57) ABSTRACT

A fiber board for use as a construction material includes self adhering compressed fragments of water-hyacinth. The fiber board preferably additionally includes one of glue, sand, cement, sawdust, metal filings, dried rice husk, banana fiber, lime and coconut waste, integrated into the self adhering fragments of water hyacinth. A method of manufacturing a fiber board includes the steps of gathering quantities of water-hyacinth from the surfaces of bodies of water; chopping and pulping the quantities of water-hyacinth into fragments; providing the fragments with moisture; and compressing the moist fragments into a desired fiber board shape.

### BACKGROUND OF THE INVENTION

1. Field of the Invention

The present invention relates generally to the field of construction materials. More specifically the present invention relates to an inventive fiber board and method of manufacture, the fiber board being formed of fragments of an extremely common weed which floats on the surfaces of rivers all over the world, this weed being known generally as water-hyacinth. The method of manufacture includes the steps of harvesting the water-hyacinth by gathering it from the water surface, chopping and pulping the entire water-hyacinth such as in a blender into fragments which are a maximum of 5 millimeters in breadth and width, and compressing the water-hyacinth pulp mixed with moisture with a force of at least 1000 pounds per square inch (psi) into a desired fiber board shape. The water-hyacinth is preferably washed before it is pulped. The selection of water-hyacinth as the working material for the claimed method of manufacture is itself an essential step in the method. Desired levels of hardness and strength of and self-adhesion among the fibers making up the fiber board are imparted in any of several ways. One way is to add an optional step of drying the water-hyacinth fiber with steam or in a kiln. Other ways are to alter and select the magnitude of the essential steps of pulping and compressing. Desired levels of hardness and strength of and self-adhesion among the fibers making up the fiber board are still further imparted by adding various granular or fragmented substances to the pulped fiber to form an aggregate prior to the compression step. Finally, while glue is not necessary to this method of fiber board manufacture, glue nevertheless may be added to the water-hyacinth prior to compression to impart added strength characteristics for specific applications. Thus the working characteristics of the fiber board are selected to meet requirements for a specific application. The resulting fiber board can be sawed, can solidly receive nails and screws much like wood, can be molded or cast into any desired board shape and securely bonded to conventional laminates, and has many other desirable construction characteristics.

2. Description of the Prior Art

There have long been composite panels for constructing walls and other interior elements of a building, these panels typically being formed of chipped, glued and compressed wood. A problem with these prior composite panels has been that the wood chips from which they are manufactured are costly and deplete an important natural resource. Glue, which is necessary for holding the wood chips together, is an added expense and complicates the manufacturing process. Yet another problem is that the glue makes wood chip board heavier than similar sized solid planks formed of the very wood from which it is manufactured, making it relatively costly to transport. Finally the prior chip board is inflammable.

Applicant has become aware of the very common, fast growing and river clogging weed known as water-hyacinth which floats on the surfaces of eighty percent of rivers all over the world, and requires continuous removal. The State of Florida, for example, has spent upwards of ten million dollars in removing water-hyacinth from rivers and lakes. Since the water-hyacinth is removed for destruction as an environmental nuisance, it becomes a highly inexpensive and widely available raw material. Applicant has discovered a method by which a fiber board having numerous desirable characteristics can be manufactured from water-hyacinth.

The history of and problems caused by water-hyacinth have been described by the Bureau of Invasive Plant Management of the Florida Department of Environmental Protection, in a publication entitled WEED ALERT, Water-Hyacinth as follows:

“This native of South America is now considered a major weed species in more than 50 countries. The floating water-hyacinth was introduced into Florida in the 1880's and covered more than 120,000 acres of public lakes and navigable rivers by the early 1960's. Since then, intensive management efforts coordinated by the Florida Department of Environmental Protection and the U.S. Army Corps of Engineers have reduced water hyacinth to approximately 2000 acres statewide.

“Water-hyacinth—The growth rate of water-hyacinth is among the highest of any known plant. In Florida, water-hyacinth populations can double their size in as little as 2 weeks by sending off short runner stems that develop new plants (daughter plants). Water-hyacinth also has the ability to reproduce by seeds.

“Why water-hyacinth must be managed: Water-hyacinth blocks waterways and limits boat traffic, recreation, flood control and wildlife use. By producing a dense canopy at the water surface, this exotic pest plant shades out native submersed plant species and can uproot native emergent species that are important to wildlife.

“Environmental damage caused by water-hyacinth populations:

Water-hyacinth mats lower dissolved-oxygen concentrations, damaging fish populations.

one acre of water-hyacinth can yearly deposit as much as 500 tons of rotting plant material on the bottom of a waterway.

Water-hyacinth mats can increase flooding in rivers and canals by forming dams.

Water-hyacinth mats provide ideal breeding environments for mosquitos.

Water-hyacinth populations decrease biodiversity in Florida.”

What is needed is a light weight and heat resistant fiber board and a method of forming the fiber board from a highly inexpensive, common and readily accessible fiber material without the use of glue.

It is thus an object of the present invention to provide a method of manufacturing a fiber board and resulting fiber board which is highly inexpensive, light weight and durable.

It is another object of the present invention to provide such a method and fiber board which is does not produce a flame when subjected to intense heat, is a good heat insulator, a good electrical insulator and a good sound barrier for sound proofing.

It is still another object of the present invention to provide such a method and fiber board which has the working characteristics of wood, into which nails and screws can be driven and the saw blade can cut, so that it is a versatile construction material.

It is finally an object of the present invention to provide such a method and fiber board which is moldable and into which various elements can be incorporated to produce specific desired characteristics.

### SUMMARY OF THE INVENTION

The present invention accomplishes the above-stated objectives, as well as others, as may be determined by a fair reading and interpretation of the entire specification.

A fiber board is provided for use as a construction material, including self adhering compressed fragments of water-hyacinth. The fiber board preferably additionally includes one of glue, sand, cement, sawdust, metal filings, dried rice husk, banana fiber, lime and coconut waste, integrated into the self adhering fragments of water hyacinth.

A method of manufacturing a fiber board is provided, including the steps of gathering quantities of water-hyacinth from the surfaces of bodies of water; chopping and pulping the quantities of water-hyacinth into fragments; providing the fragments with moisture; and compressing the moist fragments into a desired fiber board shape. The water-hyacinth preferably is pulped in a blender. The fragments of water-hyacinth preferably are pulped to a maximum of 5 millimeters in breadth and width. The fragments of water-hyacinth preferably are compressed with a force of at least 1000 pounds per square inch. The method preferably includes the additional steps of washing the fragments water-hyacinth prior to compression and of drying the fragments of welter-hyacinth after fragment compression. The method optionally includes the additional steps of mixing the fragments of water-hyacinth with one of glue, sand, cement, sawdust, metal filings, dried rice husk, banana fiber, lime and coconut waste, of placing layers of the fragments of water-hyacinth between net material for added fiber board strength, and of laminating the fiber board after compression.

### BRIEF DESCRIPTION OF THE DRAWINGS

Various other objects, advantages, and features of the invention will become apparent to those skilled in the art from the following discussion taken in conjunction with the following drawings, in which:

FIG. 1 is a perspective view of a harvesting vessel V harvesting a quantity of water-hyacinth from the surface S of a body of water.

FIG. 2 is a side view of the harvesting vessel of FIG. 1.

FIG. 3 is a perspective view of the quantity of harvested water-hyacinth being washed, combined with additives A and pulped.

FIG. 4 is a perspective view of the quantity of harvested and pulped water-hyacinth being mixed in a mixer M with the additives A.

FIG. 5 is a perspective view of the quantity of harvested water-hyacinth being passed underneath a compression roller R.

FIG. 6 is a block diagram of the preferred method of manufacture.

FIG. 7 is a perspective view of the quantity of harvested and pulped water-hyacinth being compressed into its desired board configuration in a compressor C.

FIG. 8 is a perspective view of the quantity of harvested water-hyacinth being dried in a kiln K.

FIG. 9 is a perspective view of the resulting fiber board 10 formed from fragments 12 of water-hyacinth WH.

### DETAILED DESCRIPTION OF THE PREFERRED EMBODIMENTS

As required, detailed embodiments of the present invention are disclosed herein; however, it is to be understood that the disclosed embodiments are merely exemplary of the invention which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Reference is now made to the drawings, wherein like characteristics and features of the present invention shown in the various FIGURES are designated by the same reference numerals.

### First Preferred Embodiment

Referring to FIG. 9 a fiber board 10 and method of manufacture are disclosed which is formed of fragments 12 of an extremely common weed which floats on the surfaces of rivers all over the world, this weed being known as Eichhornia crassipes or as water-hyacinth (hereinafter water-hyacinth).

### Method

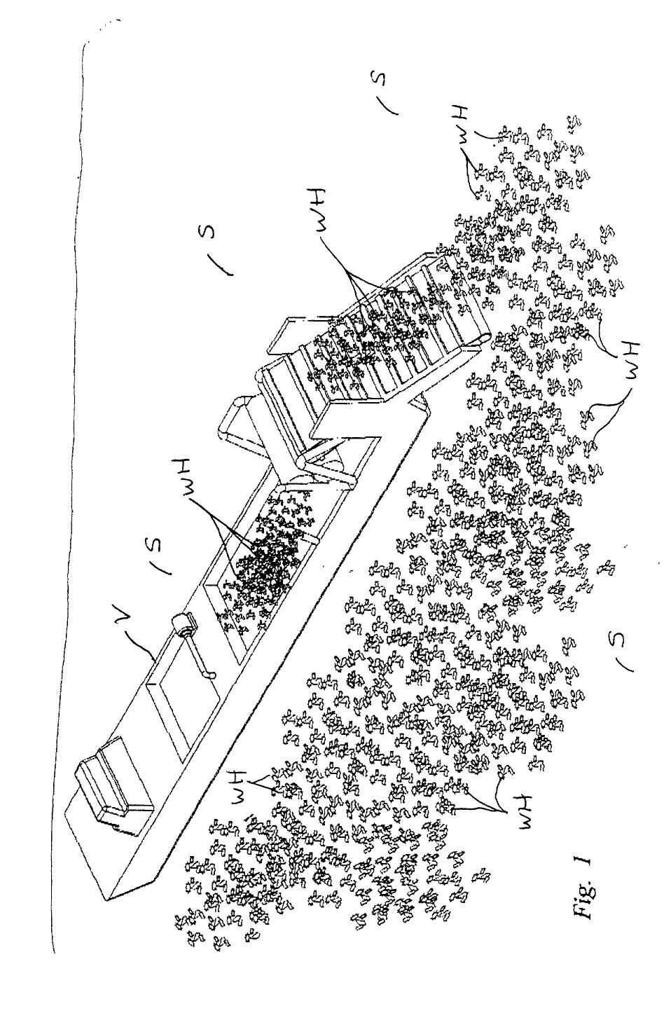

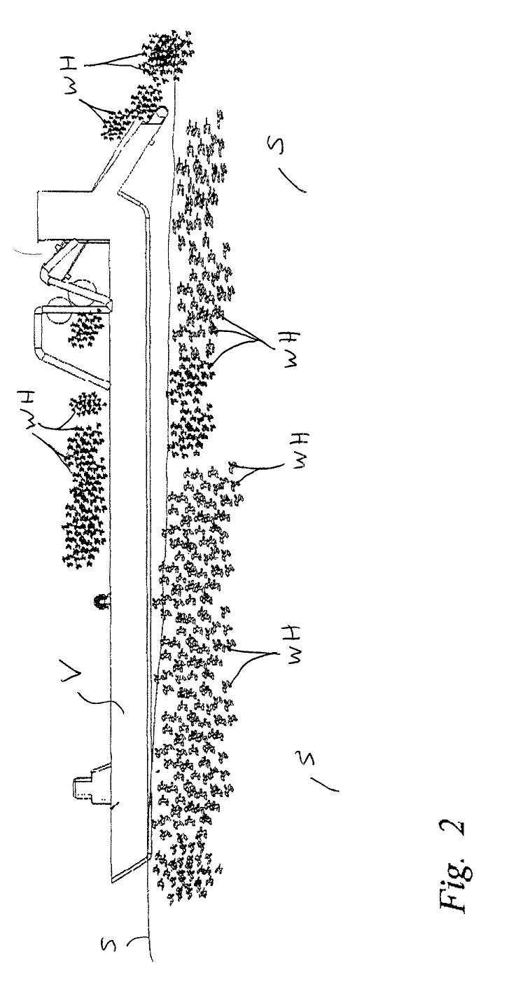

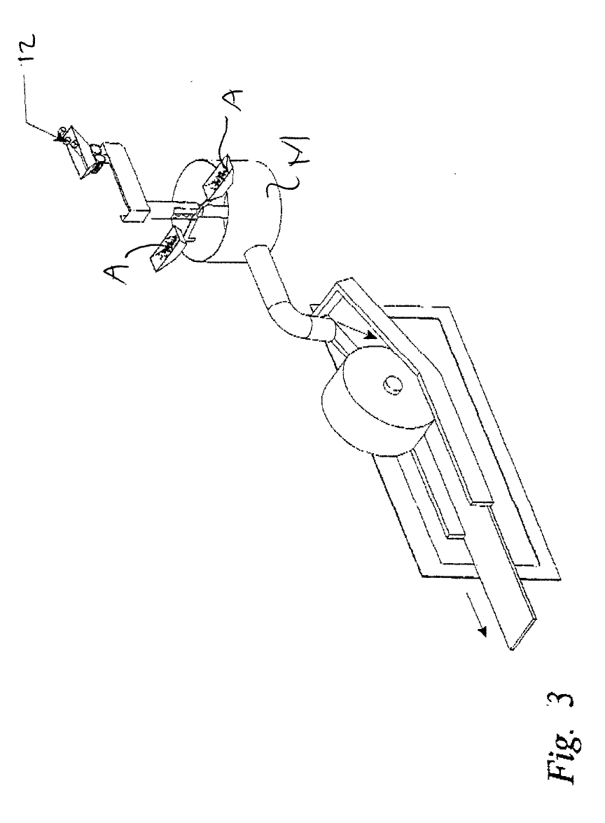

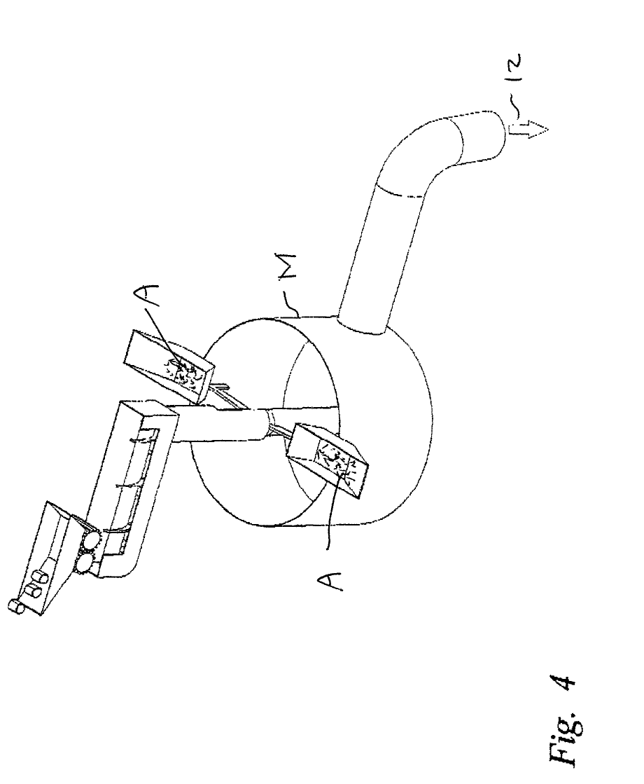

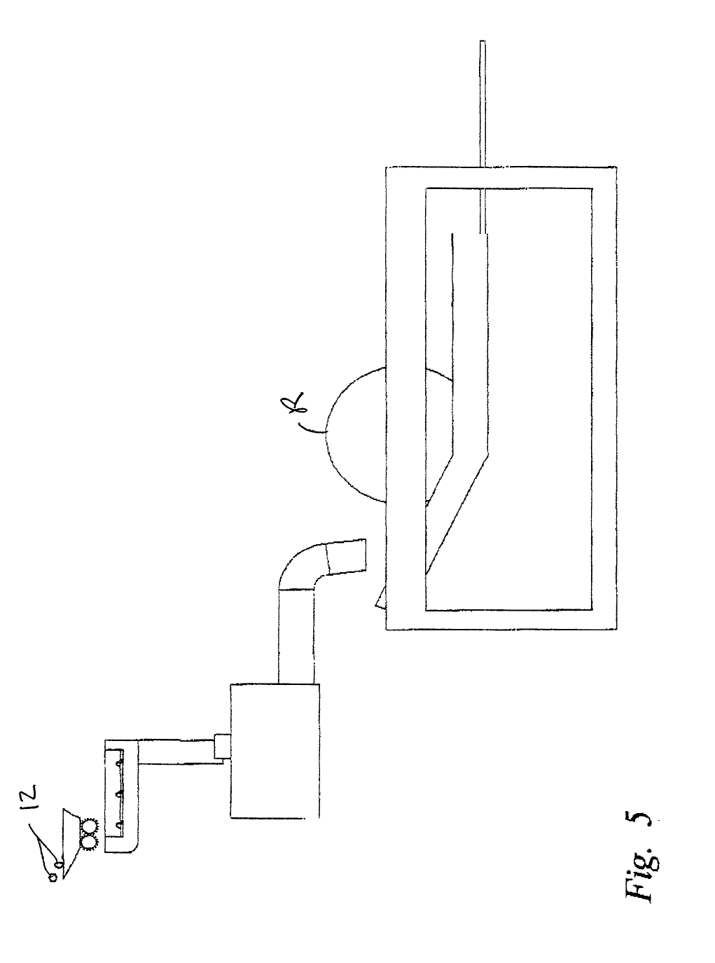

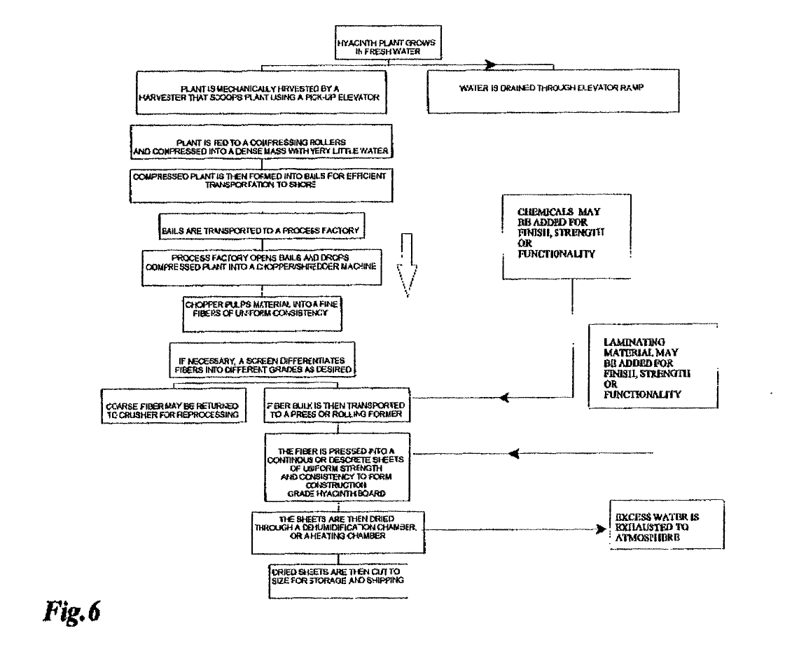

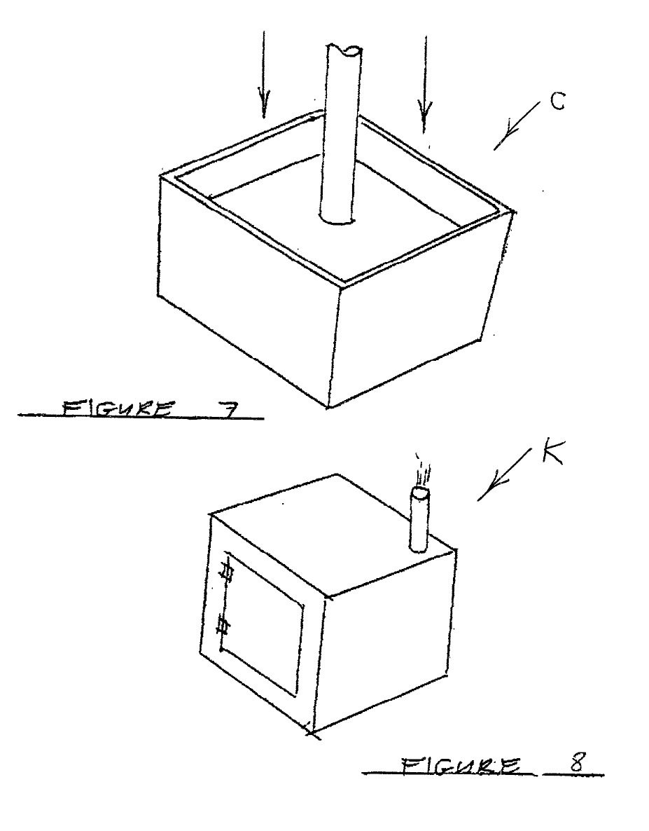

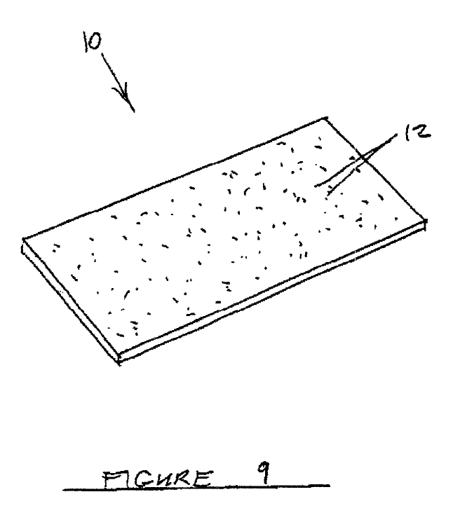

In practicing the invention, the following method of manufacturing the fiber board is used. Referring to FIGS. 1-9, the method includes the steps of harvesting the water-hyacinth WH by gathering it from the water surface, chopping and pulping the entire water-hyacinth WH such as in a blender into fragments which are a maximum of 5 millimeters in breadth and width but of various lengths depending on fiber board application, and compressing the water-hyacinth WH pulp mixed with moisture with a force of at least 1000 pounds per square inch (psi) into a desired fiber board shape. The water-hyacinth WH is preferably washed before it is pulped. The selection of water-hyacinth WH as the working material for the claimed method of manufacture is itself an essential step in the method. Execution of the same method on other plant fibers, such as wood cellulose, produces a fiber board which simply falls apart after compression unless impregnated with glue.

Desired levels of hardness and strength of and self-adhesion among the fibers making up the fiber board are imparted in any of several ways. One way is to add an optional step of drying the water-hyacinth WH fiber with steam or in a kiln.

Other ways are to alter and select the magnitude of the essential steps of pulping and compressing. The more finely the water-hyacinth WH is pulped, the greater the bonding of pulp fibers during compression and the greater the resulting fiber board hardness. Application of 1000 psi compression imparts the minimum self-adhesion needed to maintain the integrity of the fiber board. Higher compressive force, such as up to 3000 psi or higher, imparts greater fiber board hardness and bending strength, in direct proportion to the magnitude of the compressive force.

Desired levels of hardness and strength of and self-adhesion among the fibers making up the fiber board are still further imparted by adding various granular or fragmented substances to the pulped fiber to form an aggregate prior to the compression step. Sand, cement or sawdust can be added up to 25 percent by volume. Metal filings can be added to make the fiber board magnetic. Cement can be added to make the fiber board waterproof. Other optional additives include dried rice husk, banana fiber and lime. Coconut waste is desirable because it is dumped in vast quantities as production waste. Almost any material can be added to increase bulk, up to a certain percentage by volume. Examples of acceptable ranges are 20% to 50% cement by volume, 25 to 50% sawdust by volume. Layers of netting or conventional laminate layers can be placed within the harvested water-hyacinth WH after the execution of the pulping step and prior to execution of the compression step increase fiber board strength and durability. Finally, while glue is not necessary to this method of fiber board manufacture, glue nevertheless may be added to the water-hyacinth WH prior to compression to impart added strength characteristics for specific applications. Thus the working characteristics of the fiber board are selected to meet requirements for a specific application.

The resulting fiber board can be sawed, can solidly receive nails and screws much like wood, can be molded or cast into any desired board shape and securely bonded to conventional laminates. This fiber board is as moisture resistant as chipboard, and in fact better because chipboard swells to a larger size when wet and remains swelled after drying, whereas the present fiber board swells to some extent when wet but then shrinks to its original dimensions upon drying. Furthermore, this fiber board is fire resistant, falling to ashes when resting on red hot steel without producing a flame. The fiber board makes an excellent electrical insulator, having electric resistance of up to 400 giga-ohms at 10,000 volts, and also makes an excellent heat insulator. The fiber board may be a molded base covered with a suitable plastic, so that the fiber board functions as a fire resistant door or panels. The fiber board does not produce a flame when exposed to extreme heat, but ultimately is reduced to ash with an extremely slow smolder and without burning. In fact the fiber board makes an extremely good heat and cold insulation product, for use in ceilings and lofts. The thermal conductivity may be as low as 0.1 BTU per hour foot per degree. The fiber board is also a good sound insulator, and thus is well suited to incorporation into sound proofing doors and panels. Thus, once again, versions of the fiber board can be manufactured having different desired characteristics.

While the invention has been described, disclosed, illustrated and shown in various terms or certain embodiments or modifications which it has assumed in practice, the scope of the invention is not intended to be, nor should it be deemed to be, limited thereby and such other modifications or embodiments as may be suggested by the teachings herein are particularly reserved especially as they fall within the breadth and scope of the claims here appended.

I claim as my invention:

1. A fiber board for use as a construction material, comprising:
self adhering compressed fragments of water-hyacinth.

2. The fiber board of claim 1, additionally comprising one of glue, sand, cement, sawdust, metal filings, dried rice husk, banana fiber, lime and coconut waste, integrated into said self adhering fragments of water hyacinth.

3. A method of manufacturing a fiber board, comprising the steps of:
gathering quantities of water-hyacinth from the surfaces of bodies of water;
chopping and pulping the quantities of water-hyacinth into fragments;
providing the fragments with moisture;
and compressing the moist fragments into a desired fiber board shape.

4. The method of claim 3, wherein the water-hyacinth is pulped in a blender.

5. The method of claim 3, wherein the fragments of water-hyacinth are pulped to a maximum of 5 millimeters in breadth and width.

6. The method of claim 3, wherein the fragments of water-hyacinth are compressed with a force of at least 1000 pounds per square inch.

7. The method of claim 3, additionally comprising the step of:
washing the fragments water-hyacinth prior to compression.

8. The method of claim 3, additionally comprising the step of drying the fragments of water-hyacinth after fragment compression.

9. The method of claim 3, additionally comprising the step of mixing the fragments of water-hyacinth with one of glue, sand, cement, sawdust, metal filings, dried rice husk, banana fiber, lime and coconut waste.

10. The method of claim 3, additionally comprising the step of placing layers of the fragments of water-hyacinth between net material for added fiber board strength.

11. The method of claim 3, additionally comprising the step of laminating the fiber board after compression.
